(19) United States
(12) Patent Application Publication
(10) Pub. No.: US 2007/0115486 A1
(43) Pub. Date: May 24, 2007

(54) FILM FORMING DEVICE, AND PRODUCTION METHOD FOR OPTICAL MEMBER

(75) Inventor: Takayuki AKIYAMA, Yamato-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Nikon Corporation, Tokyo (JP)

(21) Appl. No.: 11/627,268

(22) Filed: Jan. 25, 2007

Related U.S. Application Data
(62) Division of application No. 10/867,631, filed on Jun. 14, 2004.
Application No. 10/867,631 is a continuation of application No. PCT/JP02/13168, filed on Dec. 17, 2002.

(30) Foreign Application Priority Data
Dec. 19, 2001 (JP) 2001-385613
Oct. 31, 2002 (JP) 2002-319149

(51) Int. Cl. G01B 11/28

(52) U.S. Cl. 356/630

(57) ABSTRACT

The optical member used in an actual-use wavelength region in the infrared region has a substrate and an optical thin film consisting of a plurality of layers that are formed on the substrate. The film forming apparatus comprises an optical monitor which measures the spectroscopic characteristics in a specified wavelength region in the visible region, an optical monitor which measures the spectroscopic characteristics in a specified region in the infrared region, and an actual-use wavelength region optical monitor which measures the spectroscopic characteristics in the actual-use wavelength region. The film thicknesses of the respective layers that are formed are determined on the basis of the spectroscopic characteristics measured by either the monitor or monitor, and the set film thickness values of layers that have not yet been formed are adjusted on the basis of these film thicknesses. The spectroscopic characteristics of the optical thin film during film formation and following the completion of film formation that are measured by the actual-use wavelength region optical monitor are reflected when the next optical thin film is formed on the next substrate.

The present application is a Divisional Application of U.S. application Ser. No. 10/867,631, filed Jun. 14, 2004, which is a Continuation of PCT International Application No. PCT/JP02/13168 filed on Dec. 17, 2002, which is hereby incorporated by reference.

### SPECIFICATION

1. Technical Field

The present invention relates to a film forming apparatus for forming a film consisting of a plurality of layers on the surface of a substrate, and a method for manufacturing an optical member which has a substrate and an optical thin film consisting of a plurality of layers that is formed on the surface of this substrate.

2. Background Art

In optical members such as optical filters, lenses, and reflective mirrors, optical thin films composed of a plurality of layers are often formed on the surfaces of such optical members for the purpose of adjusting the transmissivity or reflectivity at respective wavelengths to specified characteristics, adjusting the phase characteristics at respective wavelengths to specified characteristics, or providing anti-reflection properties. The number of layers in such films may reach several tens of layers, and specified optical characteristics are obtained by controlling the thicknesses of the respective layers constituting such optical thin films. A film forming apparatus such as a sputtering apparatus and a vacuum evaporation apparatus is used to form such optical thin films and other films.

In conventional film forming apparatuses, a visible region optical monitor which measures the spectroscopic characteristics in wavelength regions within the visible region according to the layers that are formed in the film is mounted, and an attempt is made to obtain a film with desired characteristics that are accurately reproduced by determining the film thicknesses of the respective layers that are formed on the basis of the spectroscopic characteristics measured by this visible region optical monitor, and by causing the film thicknesses of the respective layers of stages formed up to certain intermediate layers to be reflected in the film thicknesses of layers that are subsequently formed. For example, such a technique is described in Japanese Patent Application Kokai No. 2001-174226.

However, in such conventional film forming apparatuses, only a visible region optical monitor is mounted as an optical monitor for measuring the spectroscopic characteristics created by the layers that are formed. As a result, various inconveniences (which will be described below) have been encountered. In the following description, a case in which an optical thin film is formed will be described as an example; however, the facts described below also apply to films other than optical thin films.

For example, in optical members that are used in specified wavelength regions in the infrared region, such as optical members used for optical communications, the film thicknesses of the respective layers that constitute the optical thin film become greater as a result of the fact that the use wavelength is longer. When the respective layers of such optical thin films are successively formed so that the overall film thickness of the film that is formed increases, a large and abrupt repetitive variation with respect to changes in wavelength appears in the spectroscopic characteristics (e.g., spectroscopic transmissivity characteristics) in the visible region. The reason for this is that the reflected light at the boundaries of the respective layers in the short-wavelength region is superimposed so that higher-order interference occurs, and the spectroscopic characteristics created as a result of this interference generally have a steep wavelength dependence.

Meanwhile, the resolution of the visible region optical monitor is determined mainly by the resolution of the spectroscope, and has the following sensitivity distribution: specifically, the light that is detected as the amount of received light at a given wavelength is not only the light of this wavelength, but also light at wavelengths in a band centered on this wavelength. Consequently, even in cases where light which has wavelength characteristics with an ideal δ function type is incident on the light receiver, the observed spectroscopic characteristics do not have a δ function type, but are blunted.

Accordingly, when the overall film thickness of the film that is formed increases, visible region spectroscopic characteristics in which a large and abrupt repetitive variation appears with respect to changes in wavelength should be measured “as is”; however, the spectroscopic characteristics that are actually obtained using a visible region optical monitor are blunted characteristics which show no great variation with respect to changes in wavelength. Thus, when the overall film thickness that is formed increases, the measurement precision of the visible region optical monitor drops. Accordingly, in the conventional film forming apparatuses described above, when the overall film thickness that is formed increases, it becomes impossible to determine the film thickness with good precision, and therefore becomes difficult to obtain optical thin films with desired optical characteristics that are accurately reproduced.

Accordingly, in the conventional film forming apparatuses described above, the respective layers are actually also formed in the same manner on a monitoring substrate (e.g., a glass substrate), which is used as a dummy substrate for the measurement of the film thickness, in addition to being formed on the substrate of the optical member that is being manufactured. The spectroscopic characteristics of the monitoring substrate are measured using a visible region optical monitor, and when the overall film thickness of the layers or number of layers formed on the monitoring substrate exceeds a specified value during film formation, the monitoring substrate is replaced with a fresh monitoring substrate. In this case, even if the overall film thickness and number of layers of the optical thin film that is formed on the original substrate are large, the layer thickness and number of layers on each monitoring substrate are limited to specified values; accordingly, the film thicknesses of the respective layers can be measured with good precision. In this case, however, since time is required for the replacement of the monitoring substrate, the productivity drops.

Furthermore, in the conventional film forming apparatuses described above, only a visible region optical monitor is mounted; accordingly, in cases where an optical member used in a specified wavelength region in the infrared region is manufactured, as in optical members used for optical communications or the like, the optical characteristics in this specified wavelength region (the wavelength region in which the optical member is actually used) cannot be ascertained. Consequently, in the conventional film forming apparatuses described above, in cases where an attempt is made to obtain optical thin films having desired optical characteristics with better precision in a subsequent batch by determining the set film thickness values and film formation conditions of the respective layers that are used in this subsequent batch (i.e., that are used in the film formation of subsequent optical thin films on subsequent substrates) on the basis of information obtained for the current batch (i.e., information obtained during the formation of the current optical thin films on the current substrates), only the film thicknesses of the respective layers obtained for the current batch can be used as this information; the optical characteristics of the optical member in the actual-use wavelength region cannot be utilized. Accordingly, in the conventional film forming apparatuses described above, it is difficult from this standpoint as well to obtain optical thin films having desired optical characteristics that are accurately reproduced.

### DISCLOSURE OF THE INVENTION

The present invention was devised in light of such facts; the object of the present invention is to provide a film forming apparatus and an optical member manufacturing method which make it possible to solve at least one of the various problems that arise in the conventional film forming apparatuses described above.

The first invention that is used to achieve this object is a film forming apparatus for forming a film consisting of a plurality of layers on the surface of a substrate, this film forming apparatus comprising a first optical monitor which measures the spectroscopic characteristics arising from the formed layers in a first wavelength region, and a second optical monitor which measures the spectroscopic characteristics arising from the formed layers in a second wavelength region.

The second invention that is used to achieve this object is the first invention, which is characterized in that the first wavelength region is a wavelength region within the visible region, and the second wavelength region is a wavelength region within the infrared region.

The third invention that is used to achieve this object is the first invention, which is characterized in that the first and second wavelength regions are wavelength regions within the infrared region, and the second wavelength region is a partial wavelength region within the first wavelength region.

The fourth invention that is used to achieve this object is the second or third invention, which is characterized in that the second wavelength region includes a specified wavelength region in which the film is used.

The fifth invention that is used to achieve this object is any of the first through fourth inventions, which is characterized in that the apparatus comprises means for determining the film thicknesses of the respective layers that are formed on the basis of the spectroscopic characteristics measured by the first optical monitor or the spectroscopic characteristics measured by the second optical monitor, or both.

The sixth invention that is used to achieve this object is any of the first through fourth inventions, which is characterized in that the apparatus comprises means for determining the film thicknesses of the respective layers that are formed on the basis of the spectroscopic characteristics measured by the first optical monitor, and memory means for storing data indicating the spectroscopic characteristics of at least a portion of the wavelength region among the spectroscopic characteristics measured by the second optical monitor in a state in which all of the layers constituting the film have been formed.

The seventh invention that is used to achieve this object is the sixth invention, which is characterized in that the apparatus comprises memory means for storing data indicating the spectroscopic characteristics of at least a portion of the wavelength region among the spectroscopic characteristics measured by the second optical monitor in a state in which only some of the layers among the layers constituting the film have been formed.

The eighth invention that is used to achieve this object is the second invention, which is characterized in that the apparatus comprises means for determining the film thickness of the layer formed as the uppermost layer following the formation of each layer on the basis of only the spectroscopic characteristics measured by the first optical monitor or the spectroscopic characteristics measured by the second optical monitor, and these means for determining the film thickness determine the film thickness of the layer formed as the uppermost layer on the basis of only the spectroscopic characteristics measured by the first optical monitor in cases where the total thickness of the formed layers or number of formed layers is equal to or less than a specified thickness or a specified number of layers, and determine the film thickness of the layer formed as the uppermost layer on the basis of only the spectroscopic characteristics measured by the second optical monitor in cases where the total thickness of the formed layers or number of formed layers exceeds a specified thickness or a specified number of layers.

In this eighth invention, when a distinction between cases is made according to the total thickness (overall thickness) of the layers that are formed, it is desirable that the specified thickness described above be set as a specified value in the range of 1 μm to 10 μm (more preferably a specified value in the range of 6 μm to 10 μm). This is for reasons that will be described below.

It was discovered that when the film thickness of the layer formed as the uppermost layer is determined following the formation of each layer on the basis of only the spectroscopic characteristics measured by the optical monitor that measures the spectroscopic characteristics in a wavelength region within the visible region, there is a particular deterioration in the film thickness measurement precision in cases where the overall film thickness exceeds a value of approximately 10 μm. It is thought that the reason for this is that when the overall film thickness is large, variations according to wavelength in the spectroscopic transmissivity or spectroscopic reflectivity that is used to measure the film thickness become extremely severe, so that these characteristics vary greatly with only a slight variation in the wavelength. Meanwhile, the wavelength resolution of commonly used spectroscopes is approximately 0.5 nm, and if an attempt is made to measure the film thickness with a precision of approximately ±0.1 nm in regions where the film thickness exceeds a value of approximately 10 μm, the measurement precision is insufficient in the case of a spectroscope having a wavelength resolution of approximately 0.5 nm.

However, in optical elements that are actually used, the difference between design values and actual values must be kept at approximately ±0.02% in most cases; furthermore, the wavelength resolution of spectroscopic transmissivity meters or spectroscopic reflectivity meters that can ordinarily be obtained is approximately 0.5 nm. From this standpoint, in order to ensure a precision of ±0. 1 nm, which is the thickness measurement precision that is actually required, it has been indicated by experiment that it is necessary to keep at least the overall film thickness at 10 μm or less in cases where film thickness measurements are performed on the basis of only the spectroscopic characteristics measured by an optical monitor that measures the spectroscopic characteristics in a wavelength region that is within the visible region.

Meanwhile, in cases where film thickness measurements are performed on the basis of only the spectroscopic characteristics measured by an optical monitor that measures the spectroscopic characteristics in a wavelength region within the visible region, a measurement precision of ±0.1 nm can be sufficiently ensured if the overall film thickness is less than 1 μm, and there is no great drop in the measurement precision even if the overall film thickness is 1 μm or greater, but less than 6 μm.

Accordingly, it is desirable that the specified thickness that is used as reference for distinguishing cases be set as a specified value in the range of 1 μm to 10 μm, and it is even more desirable to set this specified thickness as a specified value in the range of 6 μm to 10 μm.

The ninth invention that is used to achieve the object described above is the second invention, which is characterized in that (a) the apparatus comprises means for determining the film thickness of the layer that is formed as the uppermost layer following the formation of each layer on the basis of the overall spectroscopic characteristics combining both the spectroscopic characteristics that are measured by the first optical monitor and the spectroscopic characteristics that are measured by the second optical monitor, (b) these means for determining the film thickness determine the film thickness of the layer formed as the uppermost layer by fitting the corresponding spectroscopic characteristics calculated using various assumed thicknesses of the layer formed as the uppermost layer to the overall spectroscopic characteristics, and (c) these means for determining the film thickness perform the fitting described above while giving greater weight to the spectroscopic characteristics measured by the first optical monitor than to the spectroscopic characteristics measured by the second optical monitor in cases where the overall thickness of the layers that are formed or the number of layers that are formed is equal to or less than a specified thickness or a specified number of layers, and perform the fitting described above while giving greater weight to the spectroscopic characteristics measured by the second optical monitor than to the spectroscopic characteristics measured by the first optical monitor in cases where the overall thickness of the layers that are formed or the number of layers that are formed is greater than a specified thickness or a specified number of layers.

In this ninth invention, when a distinction between cases is made according to the total thickness (overall thickness) of the layers that are formed, it is desirable that the specified thickness described above be set as a specified value in the range of 1 μm to 10 μm (more preferably a specified value in the range of 6 μm to 10 μm). This is for reasons similar to the reasons described in connection with the eighth invention described above.

The tenth invention that is used to achieve the object described above is the eighth or ninth invention, which is characterized in that the second wavelength region includes the specified wavelength region in which the film is used.

The eleventh invention that is used to achieve the object described above is any of the fifth through tenth inventions, which is characterized in that the apparatus comprises adjustment means for adjusting the set film thickness values of layers that are formed subsequent to at least one of the layers constituting the film on the basis of the film thickness determined for this layer by the means for determining the film thickness in a state in which this layer has been formed as the uppermost layer.

The twelfth invention that is used to achieve the object described above is the first invention, which is characterized in that the second wavelength region includes the specified wavelength region in which the film is used, and the apparatus comprises means for determining the film thicknesses of the respective layers that are formed, means for judging whether or not the evaluation value of the deviation between the spectroscopic characteristics in the specified wavelength region measured by the second optical monitor in a state in which only some of the layers constituting the film have been formed and the spectroscopic characteristics calculated on the basis of the film thicknesses of these same layers determined by the means for determining the film thickness is within a specified permissible range, and means for stopping the film formation of layers subsequent to these layers in cases where it is judged by the judgement means that this evaluation value is not within the specified permissible range.

The thirteenth invention that is used to achieve the object described above is a method for manufacturing an optical member which has a substrate and an optical thin film consisting of a plurality of layers formed on top of this substrate, this method comprising a step in which the respective layers constituting the optical thin film are successively formed on the basis of set film thickness values for these respective layers, and a step in which the film thicknesses of the respective layers that are formed are determined on the basis of the spectroscopic characteristics measured by at least one optical monitor among a first optical monitor that measures the spectroscopic characteristics arising from the formed layers in a first wavelength region and a second optical monitor that measures the spectroscopic characteristics arising from the formed layers in a second wavelength region.

The fourteenth invention that is used to achieve the object described above is a method for manufacturing an optical member which has a substrate and an optical thin film consisting of a plurality of layers formed on top of this substrate, this method comprising a step in which the respective layers constituting the optical thin film are successively formed on the basis of set film thickness values for these respective layers, a step in which the film thicknesses of the respective layers that are formed are determined on the basis of the spectroscopic characteristics measured by a first optical monitor that measures the spectroscopic characteristics arising from the formed layers in a first wavelength region, and a step in which the set film thickness values or film formation conditions of the respective layers constituting the next optical thin film, which are used to form this next optical thin film on the next substrate, are determined on the basis of the spectroscopic characteristics for at least a portion of the wavelength region among the spectroscopic characteristics measured by a second optical monitor that measures the spectroscopic characteristics arising from the formed layers in a second wavelength region that differs from the first wavelength region in a state in which all of the layers constituting the optical thin film have been formed.

The fifteenth invention that is used to achieve the object described above is a method for manufacturing an optical member which has a substrate and an optical thin film consisting of a plurality of layers formed on top of this substrate, this method comprising a step in which the respective layers constituting the optical thin film are successively formed on the basis of set film thickness values for these respective layers, a step in which the film thicknesses of the respective layers that are formed are determined on the basis of the spectroscopic characteristics measured by a first optical monitor that measures the spectroscopic characteristics arising from the formed layers in a first wavelength region, and a step in which the set film thickness values or film formation conditions of the respective layers constituting the next optical thin film, which are used to form this next optical thin film on the next substrate, are determined on the basis of the respective spectroscopic characteristics for at least a portion of the wavelength region among the respective spectroscopic characteristics measured by a second optical monitor that measures the spectroscopic characteristics arising from the formed layers in a second wavelength region that differs from the first wavelength region in a state in which only some of the layers constituting the optical thin film have been formed and in a state in which all of the layers constituting the optical thin film have been formed.

The sixteenth invention that is used to achieve the object described above is any of the thirteenth through fifteenth inventions, which is characterized in that the method further comprises a step in which the set film thickness values of layers that are formed subsequent to at least one of the layers constituting the optical thin film are adjusted on the basis of the film thickness determined for this layer in the step in which the film thickness is determined in a state in which this layer has been formed as the uppermost layer.

The seventeenth invention that is used to achieve the object described above is any of the thirteenth through sixteenth inventions, which is characterized in that the first wavelength region is a wavelength region within the visible region, and the second wavelength region is a wavelength region within the infrared region.

The eighteenth invention that is used to achieve the object described above is any of the thirteenth through sixteenth inventions, which is characterized in that the first and second wavelength regions are wavelength regions within the infrared region, and the second wavelength region is a partial wavelength region within the first wavelength region.

The nineteenth invention that is used to achieve the object described above is the seventeenth or eighteenth invention, which is characterized in that the optical thin film is used in a specified wavelength region within the infrared region, and the second wavelength region includes the specified wavelength region in which the optical thin film is used.

The twentieth invention that is used to achieve the object described above is a method for manufacturing an optical member which has a substrate and an optical thin film consisting of a plurality of layers formed on top of this substrate, this method comprising a step in which the optical thin film is formed on the substrate using the film forming apparatus constituting any of first through twelfth inventions.

### BRIEF DESCRIPTION OF THE DRAWINGS

FIG. 1 is a diagram which shows in model form the rotating table of film forming apparatuses constituting respective embodiments of the present invention as seen from below.

FIG. 2 is a schematic sectional view which shows in model form the essential parts of film forming apparatuses constituting respective embodiments of the present invention along line A-A′ in FIG. 1.

FIG. 3 is a schematic sectional view which shows in model form the essential parts of film forming apparatuses constituting respective embodiments of the present invention along line B-B′ in FIG. 1.

FIG. 4 is a schematic sectional view which shows in model form one example of an optical member manufactured using the film forming apparatuses constituting respective embodiments of the present invention.

FIG. 5 is a schematic block diagram which shows the essential parts of the control system of the film forming apparatuses constituting respective embodiments of the present invention.

FIG. 6 is a schematic flow chart which shows one example of the operation of a film forming apparatus constituting a first embodiment of the present invention.

FIG. 7 is a schematic flow chart which shows the operation of a film forming apparatus constituting a second embodiment of the present invention.

FIG. 8 is another schematic flow chart which shows the operation of the film forming apparatus constituting a second embodiment of the present invention.

FIG. 9 is a diagram which shows an example of the measured spectroscopic transmissivity and the calculated spectroscopic transmissivity.

FIG. 10 is a diagram which shows an example of the tolerance setting of the first layer.

FIG. 11 is a diagram which shows an example of the tolerance setting of the fifteenth layer.

FIG. 12 is a diagram which shows an example of the tolerance setting of the fortieth layer.

FIG. 13 is a diagram which shows an example of the tolerance setting for a wavelength of 550 nm.

FIG. 14 is a diagram which shows an example of the tolerance setting for a wavelength of 1600 nm.

FIG. 15 is a diagram which shows an example of the tolerance setting in a three-dimensional depiction.

### BEST MODE FOR CARRYING OUT THE INVENTION

Preferred embodiments of the film forming apparatus and optical member manufacturing method of the present invention will be described below with reference to the figures.

### FIRST EMBODIMENT

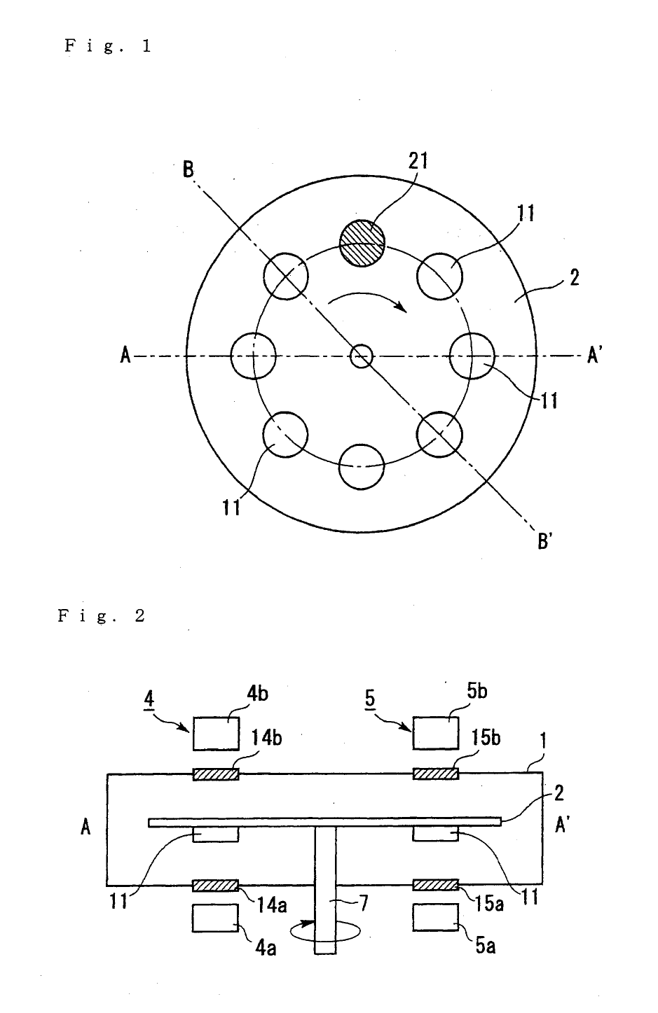

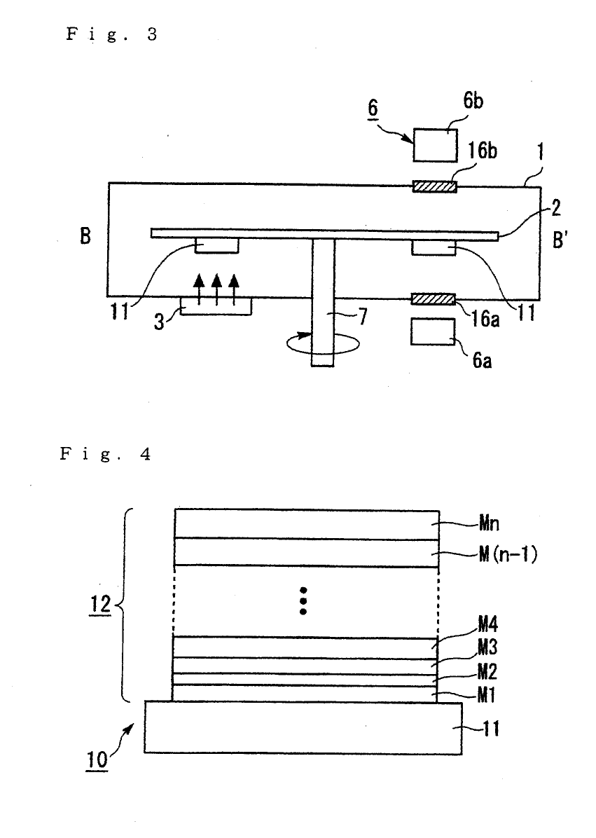

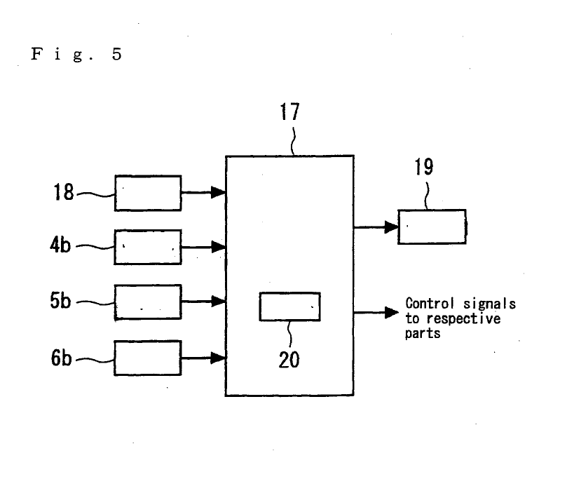

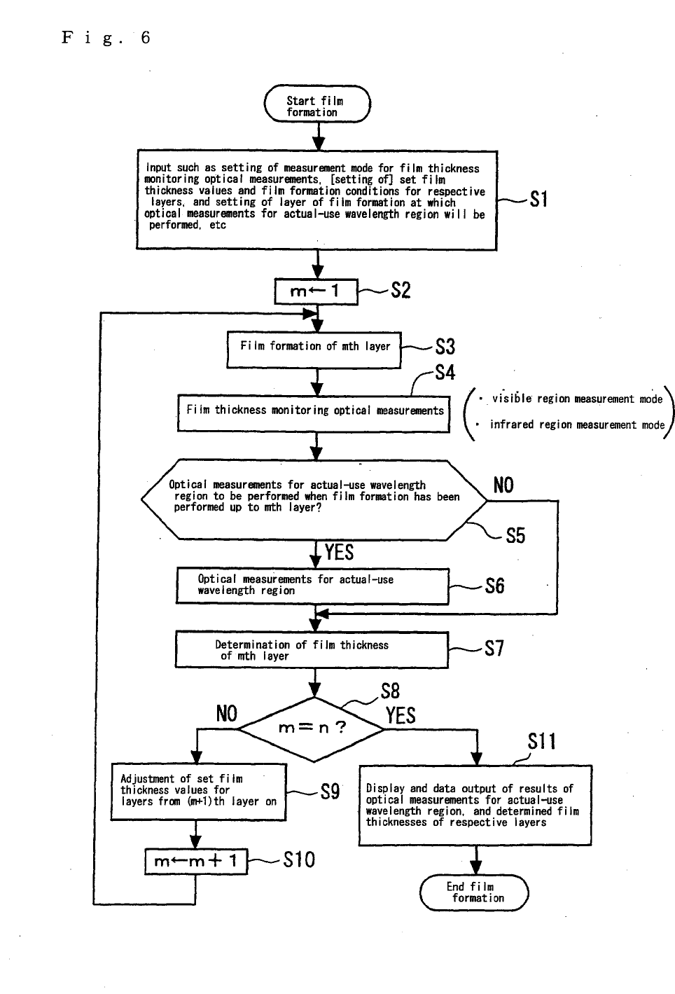

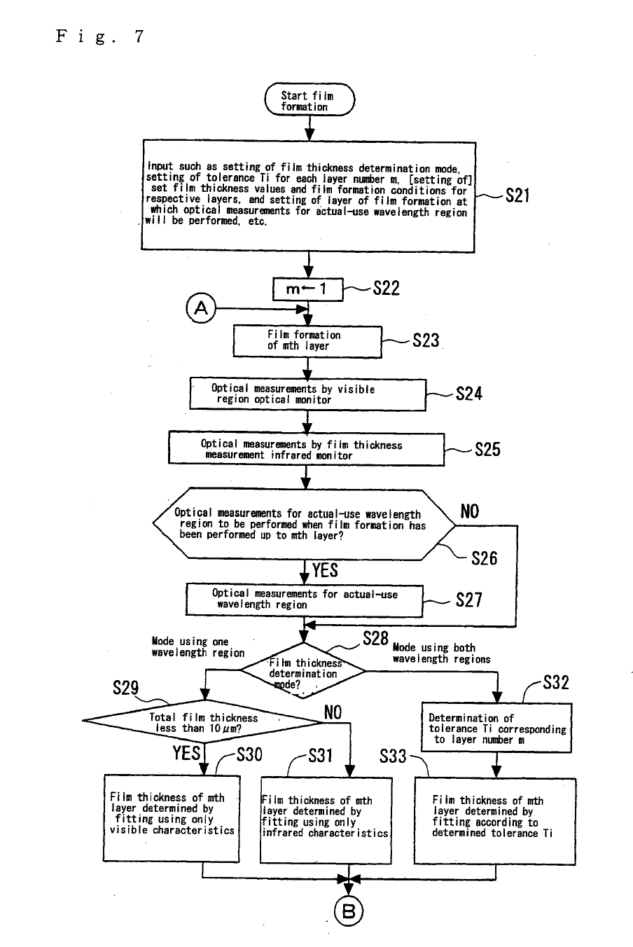

FIG. 1 is a diagram which shows in model form the rotating table of a film forming apparatus constituting a first embodiment of the present invention as seen from below. FIG. 2 is a schematic sectional view which shows in model form the essential parts of the film forming apparatus constituting the present embodiment along line A-A′ in FIG. 1. FIG. 3 is a schematic sectional view which shows in model form the essential parts of the film forming apparatus constituting the present embodiment along line B-B′ in FIG. 1. FIG. 4 is a schematic sectional view which shows in model form one example of an optical member 10 manufactured using the film forming apparatus of the present embodiment. FIG. 5 is a schematic block diagram showing the essential parts of the control system of the film forming apparatus constituting the present embodiment.

Before the film forming apparatus of the present embodiment is described, one example of an optical member 10 manufactured using this film forming apparatus will be described. In this example, the optical member 10 is an optical member that is used in a specified wavelength region (actual-use wavelength region) in the infrared region, as in the case of optical members used in optical communications, spacecrafts, satellites, or the like. For example, the actual-use wavelength region of the optical member 10 is 1520 nm to 1570 nm (i.e., the so-called C band).

This optical member 10 is constructed as an interference filter, for example, and is constructed from a substrate 11 that is a flat transparent plate (consisting of glass, etc., as this substrate), and an optical thin film 12 consisting of a plurality of layers M1 through Mn (n is an integer of 2 or greater) that are formed on top of this substrate 11. Of course, the optical member 10 is not limited to an interference filter, and may also be a lens, prism, mirror, or the like. For example, in the case of a lens, a glass member which has a curved surface, etc., is used as the substrate instead of the substrate 11.

In the present example, the layers M1 through Mn are alternating layers consisting of either a substance with a high refractive index (e.g., Nb₂O₅) or a substance with a low refractive index (e.g., SiO₂), so that the optical thin film 12 is constructed from alternating layers of two different types of substances. Of course, the optical thin film 12 may also be constructed from layers consisting of three or more different types of substances.

Desired optical characteristics (in the following description, the desired optical characteristics are spectroscopic transmissivity characteristics; however, the desired optical characteristics are not limited to these characteristics, and may also be spectroscopic reflectivity characteristics or phase characteristics, etc.) are obtained in the optical member 10 by appropriately setting the materials, number of layers n and thicknesses of the respective layers M1 through Mn.

The film forming apparatus of the present embodiment is constructed as a sputtering apparatus; as is shown in FIGS. 1 through 3, this sputtering apparatus comprises a vacuum chamber 1 used as a film forming chamber, a rotating table 2 which is disposed inside the vacuum chamber 1, two sputtering sources 3 (only one of these is shown in the figures), and three optical monitors 4, 5 and 6.

The rotating table 2 is arranged so that this table can be caused to rotate about a rotating shaft 7 by an actuator such as a motor, etc. (not shown in the figures). Substrates 11 that will constitute optical members 10, and a monitoring substrate 21, are attached via a holder (not shown in the figures) to the undersurface of the rotating table 2 in respective positions on a concentric circle centered on the shaft 7. In the example shown in FIGS. 1 through 3, seven substrates 11 and one monitoring substrate 21 are attached to the rotating table 2.

The two sputtering sources 3 are respectively disposed in two locations in the lower part of the vacuum chamber 1 which are such that these sputtering sources 3 can face the substrates 11 and 21 as the rotating table 2 rotates. In the present embodiment, particles of components that constitute the layers fly from these two sputtering sources 3, and strike the surfaces of the substrates 11 and monitoring substrate 21, so that layers are formed. In the present embodiment, the target materials are different in the two sputtering sources 3, so that the substance with a high refractive index and substance with a low refractive index (described above) respectively fly from the two sputtering sources 3.

For example, the monitoring substrate 21 consists of a transparent flat plate such as a glass substrate. Since flat substrates are used as the substrates of the optical members 10 as described above, the same substrates are used as the substrates 11 and monitoring substrate 21. The monitoring substrate 21 is a dummy substrate used for film thickness measurement (i.e., a substrate that does not ultimately become an optical member 10); the thicknesses of the films that are formed on top of the substrates 11 under the same conditions are indirectly measured by measuring the thickness of the film that is formed on the surface of this monitoring substrate 21. Depending on the case, it may not be absolutely necessary to use such a monitoring substrate 21. However, in cases where the surfaces of the optical members 10 are curved surfaces, as when the optical members 10 are lenses, accurate measurement of the film thickness on such surfaces is difficult; accordingly, it is desirable to use a monitoring substrate 21.

As is shown in FIGS. 2 and 3, three windows 14b, 15b and 16b are formed in the upper surface of the vacuum chamber 1, and three windows 14a, 15a and 16a are formed in the lower surface of the vacuum chamber 1. The pair of windows 14a and 14b are disposed so that these windows are located on either side of a specified position through which the substrates 11 and 21 pass as the rotating table 2 rotates. Another pair of windows 15a and 15b, as well as the other pair of windows 16a and 16b, are also similarly disposed.

The optical monitor 4 is constructed from a light emitting device 4a and a light receiving device 4b which splits and receives the light that is emitted from the light emitting device 4a and that passes through the window 14a, substrate 11 or monitoring substrate 21, and window 14b; this optical monitor 4 is arranged so that it can measure the spectroscopic transmissivity of the film formed on the surface of the substrate 11 or monitoring substrate 21. Similarly, the optical monitor 5 is constructed from a light emitting device 5a and a light receiving device 5b which splits and receives the light that is emitted from the light emitting device 6a and that passes through the window 15a, substrate 11 or monitoring substrate 21, and window 15b, and this optical monitor 5 is also arranged so that it can measure the spectroscopic transmissivity of the film formed on the surface of the substrate 11 or monitoring substrate 21. Similarly, the optical monitor 6 is constructed from a light emitting device 6a and a light receiving device 6b which splits and receives the light that is emitted from the light emitting device 6a and that passes through the window 16a, substrate 11 or monitoring substrate 21, and window 16b, and this optical monitor 6 is also arranged so that it can measure the spectroscopic transmissivity of the film formed on the surface of the substrate 11 or monitoring substrate 21.

The optical monitor 4 is constructed so that it measures the spectroscopic transmissivity in a specified wavelength region in the visible region, e.g., 400 nm to 850 nm. The optical monitor 5 is constructed so that this optical monitor measures the spectroscopic transmissivity in a specified wavelength region in the infrared region, e.g., 1000 nm to 1700 nm. The optical monitor 6 is constructed so that this optical monitor measures the spectroscopic transmissivity in the actual-use wavelength region of the optical members 10 (this corresponds to the wavelength region described as the “specified wavelength region in which the film is used” in the sections titled “Claims” and “Disclosure of the Invention”), e.g., 1520 nm to 1570 nm. The respective optical monitors 4 through 6 are specially constructed for the respective measurement wavelength regions.

In the present embodiment, since the measurement wavelength region of the optical monitor 5 includes the actual-use wavelength region of the optical members 10, which is the measurement wavelength region of the optical monitor 6, the actual-use wavelength region of the optical members 10 can also be measured by the optical monitor 5. Accordingly, it would be possible to omit the optical monitor 6 and to combine the function of the optical monitor 6 with the optical monitor 5. However, if the optical monitors 5 and 6 are separately constructed as in the present embodiment, the resolution of the optical monitor 6 can be increased compared to the resolution of the optical monitor 5 since the measurement wavelength region of the optical monitor 6 is narrower than the measurement wavelength region of the optical monitor 5. Accordingly, the spectroscopic transmissivity in the actual-use wavelength region can be measured with a high resolution, which is advantageous. Conversely, in cases where the spectroscopic transmissivity in the actual-use wavelength region of the optical members 10 can be used to determine the film thicknesses of the respective layers, it would be possible to omit the optical monitor 5 and to use the optical monitor 6 as a film thickness monitor as well.

In the following description, for the sake of convenience, the optical monitor 4 will be called the “visible region optical monitor,” the optical monitor 5 will be called the “film thickness measurement infrared monitor,” and the optical monitor 6 will be called the “actual-use wavelength region infrared monitor.”

As is shown in FIG. 5, the film forming apparatus of the present embodiment comprises a control and calculation processing part 17 constructed from (for example) a computer, which controls the overall apparatus and performs specified calculations and the like in order to realize the operation described below, an operating part 18 which is used by the user to input instructions and data, etc., into the control and calculation processing part 17, and a display part 19 such as a CRT. The control and calculation processing part 17 has an internal memory 20. Of course, it would also be possible to use an external memory instead of this internal memory 20. Furthermore, like other universally known film forming apparatuses, the film forming apparatus of the present embodiment also comprises a pump which is used to place the interior of the vacuum chamber 1 in a vacuum state, a gas supply part which supplies specified gases to the interior of the vacuum chamber 1, and the like. However, a description of these parts is omitted.

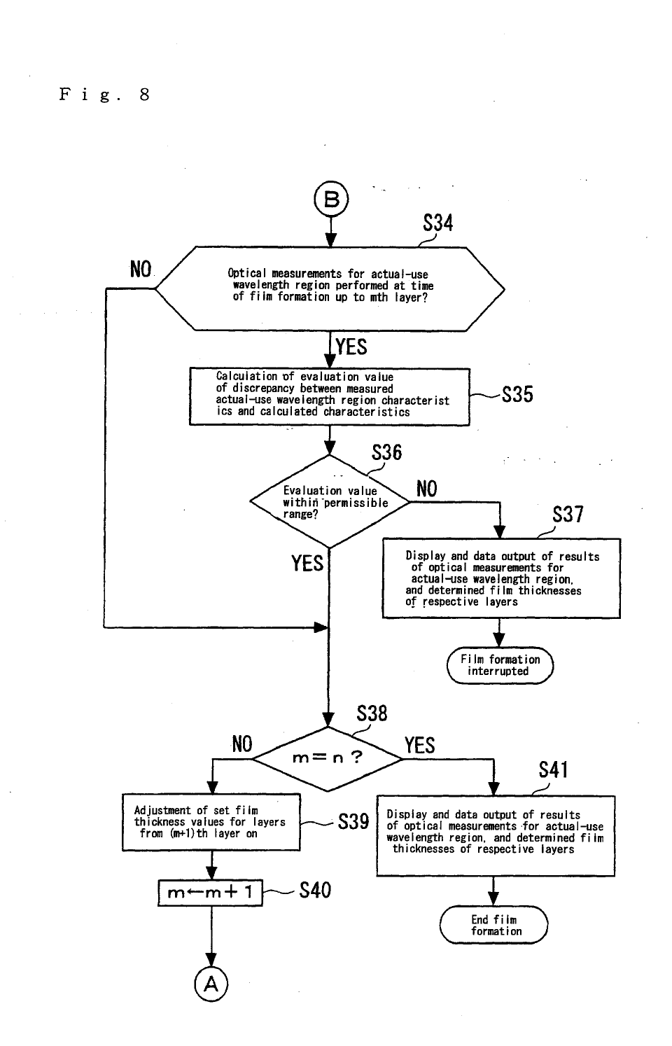

Nest, one example of the operation of the film forming apparatus of the present embodiment will be describe with reference to FIG. 6. FIG. 6 is a schematic flow chart which shows one example of the operation of the film forming apparatus of the present embodiment.

Film formation is initiated in a state in which substrates 11 and a monitoring substrate 21 on which no films have yet been formed are attached to the rotating table 2.

First, the user performs initial settings by operating the operating part 18 (step S1). In these initial settings, setting information is input which sets the measurement mode of the film thickness monitoring optical measurements performed in step S4 described below as either the visible region measurement mode (a mode in which film thickness monitoring optical measurements are performed by the visible region optical monitor 4) or the infrared region measurement mode (a mode in which film thickness monitoring optical measurements are performed by the film thickness measurement infrared monitor 5). Furthermore, in these initial settings, the set film thickness values, materials, number of layers n, film formation conditions, and the like for the respective layers M1 through Mn are input which are such that the desired optical characteristics of the optical member 10 can be obtained, and which are predetermined according to advance design or the like.

Moreover, it would also be possible to provide the control and calculation processing part 17 with a design function for the optical thin film 12 so that when the user inputs the desired optical characteristics, the control and calculation processing part 17 automatically determines the set film thickness values, materials, number of layers n, film formation conditions, and the like of the respective layers M1 through Mn in accordance with this design function. Furthermore, in these initial settings, setting information indicating the layer of film formation at which the optical measurement of the actual-use wavelength region is to be performed in step S6 (described later), etc., is also input.

For example, the selection of this layer may be set as all of the layers M1 through Mn, or may be set as only the uppermost layer Mn; alternatively, the selection may be set as the uppermost layer Mn and one or more other arbitrary layers (e.g., at every specified number of layers). A setting may also be used in which no layer is selected, and the optical measurement of the actual-use wavelength region in step S6 is not performed for any layer; at the minimum, however, it is desirable to select the uppermost layer Mn.

Next, the control and calculation processing part 17 sets a count value m which indicates the number of the current layer as counted from the side of the substrate 11 at 1 (step S2)

Then, under the control of the control and calculation processing part 17, the film formation of the mth layer is performed (e.g., by time control) on the basis of the set film thickness value and film formation conditions, etc., set for this layer (step S3). In the case of the first layer M1, film formation is performed on the basis of the set film thickness value that has been set in step S1. However, in the case of the second or subsequent layers, if the set film thickness value has been adjusted in step S9 (described later), film formation is performed on the basis of the most recently adjusted set film thickness value. During film formation, the rotating table 2 is caused to rotate, and only the shutter (not shown in the figures) disposed facing the sputtering source 3 that corresponds to the material of the mth layer is opened, so that particles from this sputtering source 3 are deposited on the respective substrates 11 and monitoring substrate 21. When the film formation of the mth layer is completed, this shutter is closed.

Subsequently, under the control of the control and calculation processing part 17, film thickness monitoring optical measurements are performed in the measurement mode that has been set in step S1 (step S4).

In cases where the visible region measurement mode is set in step Si, the spectroscopic transmissivity of the monitoring substrate 21 or substrate 11 in the specified wavelength region within the visible region described above is measured by the visible region optical monitor 4 in step S4, and this data is stored in the memory 20 in association with the current count value m. Measurements by the visible region optical monitor 4 are performed when the monitoring substrate 21 or substrate 11 in question is positioned between the light emitting device 4a and light receiving device 4b in a state in which the rotating table 2 is rotating, or are performed with the rotating table 2 stopped in a state in which the monitoring substrate 21 or substrate 11 is positioned between the light emitting device 4a and light receiving device 4b.

On the other hand, in cases where the infrared region measurement mode is set in step S1, the spectroscopic transmissivity of the monitoring substrate 21 or substrate 11 in the specified wavelength region within the infrared region described above is measured by the film thickness measurement infrared monitor 5, and this data is stored in the memory 20 in association with the current count value m. Measurements by the film thickness measurement infrared monitor 5 are performed when the monitoring substrate 21 or substrate 11 in question is positioned between the light emitting device 5a and light receiving device 5b in a state in which the rotating table 2 is rotating, or are performed with the rotating table 2 stopped in a state in which the monitoring substrate 21 or substrate 11 is positioned between the light emitting device 6a and light receiving device 5b.

Basically, in step S4, the spectroscopic transmissivity characteristics of either the monitoring substrate 21 or substrate 11 may be measured in either measurement mode. Furthermore., for each layer, the spectroscopic transmissivitv characteristics of either the monitoring substrate 21 or substrate 11 may be arbitrarily set beforehand by the user as the spectroscopic transmissivity characteristics that are measured.

When the film thickness monitoring optical measurements performed in step S4 are completed, the control and calculation processing part 17 judges whether or not the actual-use wavelength region optical measurements of step S6 are to be performed when film formation has been performed up to the current mth layer (i.e., in the state in which the mth layer has been formed as the uppermost layer) (step S5), on the basis if the setting information that has been set in step S1. If it is judged that the actual-use wavelength region optical measurements are not to be performed, the processing proceeds directly to step S7, while if it is judged that the actual-use wavelength region optical measurements are to be performed, the processing proceeds to step S7 after passing through step S6.

In step S6, the spectroscopic transmissivity of the monitoring substrate 21 or substrate 11 in the actual-use wavelength region described above is measured by the actual-use wavelength region infrared monitor 6, and this data is stored in the memory 20. Measurements by the actual-use wavelength region infrared monitor 6 are performed when the substrate 11 is positioned between the light emitting device 6a and light receiving device 6b in a state in which the rotating table 2 is rotating, or are performed with the rotating table 2 stopped in a state in which the substrate 11 is positioned between the light emitting device 6a and light receiving device 6b.

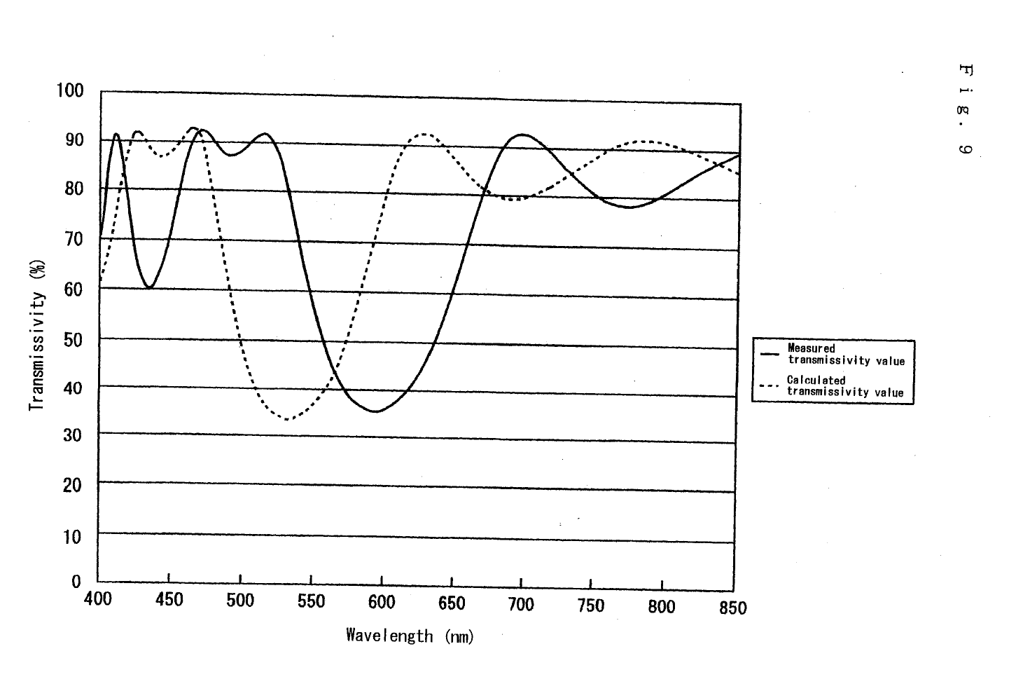

In step S7, the control and calculation processing part 17 determines the film thickness of the current mth layer on the basis of the spectroscopic transmissivity characteristics measured in step S6. In regard to the actual procedure that is used to determine the film thickness from the spectroscopic transmissivity characteristics, various types of publicly known procedures, or fitting similar to that performed in steps S30 and S31 (shown in FIG. 7 described later), may be employed.

Next, the control and calculation processing part 17 judges whether or not m=n, i.e., whether or not film formation has been completed up to the final layer Mn (step S8). If this film formation has not been completed, the set film thickness values for the layers from the (m+1)th layer on (i.e., the layers that have not yet been formed) are adjusted and optimized on the basis of the respective film thicknesses determined in step S6 for each layer up to the mth layer so that the optical characteristics of the optical member 10 that will ultimately be obtained are adjusted to the desired optical characteristics (step S9). For example, such optimization can be performed using various types of publicly known procedures. The set film thickness values for the layers from the (m+1)th layer on that are adjusted in this step S9 are used in step S3 when the layers from the (m+1)th layer on are formed. Following the adjustment performed in step S9, the count value m of the number of layers is increased by 1 (step S10), and the processing returns to step S3.

On the other hand, if it is judged in step S8 that film formation up to the final layer Mn has been completed, the spectroscopic transmissivity characteristics in the actual-use wavelength region measured in each step S6, and the film thicknesses of the respective layers determined in each step S7, which are stored in the memory 20, are displayed on the display part 19 along with the associated count values m (information indicating which layer was formed as the uppermost layer at the time that the data was obtained), and if necessary, this data is output to an external personal computer, etc. (step S11); with this, the formation of the optical thin film 12 on the substrate 11 is completed.

Optical members 10 can be manufactured in this manner.

Furthermore, on the basis of the film thicknesses of the respective layers and the spectroscopic transmissivity characteristics in the actual-use wavelength region that are displayed or output in step S11, the user determines the set film thickness values and film formation conditions of the respective layers that are to be set in step S1 when the next optical thin film 12 is formed on the next substrate 11 (from a comparison of the above data with the initial set film thickness values of the respective layers and desired optical characteristics of the optical member 10) so that optical characteristics that are closer to the desired optical characteristics can be obtained when the next optical thin film 12 is formed on the next substrate 11. When the next optical thin film 12 is formed on the next substrate 11, the set film thickness values and film formation conditions of the respective layers thus determined are set in step S1.

Thus, in the present embodiment, feedback in which information that is obtained when the optical thin film 12 is formed on the current substrate 11 is reflected in the set film thickness values and film formation conditions for the respective layers that are set in step S1 when the next optical thin film 12 is formed on the next substrate 11 can be performed via the user.

However, it is also possible to automate the processing by endowing the control and calculation processing part 17 with such a feedback function. In this case, for example, a look-up table or the like which shows the correspondence between the information that is obtained when the optical thin film 12 is formed on the current substrate 11 and the set film thickness values and film formation conditions for the respective layers that are to be initially set when the next optical thin film 12 is formed on the next substrate 11 may be constructed beforehand, and the system may be constructed so that the control and calculation processing part 17 performs the feedback described above by referring to this look-up table or the like.

The various advantages described below can be obtained in the present embodiment.

To describe the first advantage, in the present embodiment, regardless of which measurement mode is set as the measurement mode of the film thickness monitoring optical measurements performed in step S4, if the layer that determines the timing of the measurement of the optical characteristics in the actual-use wavelength region within the infrared region in step S6 is set as the uppermost layer Mn in step S1, the spectroscopic transmissivity characteristics (in the actual-use wavelength region within the infrared region) of the optical member 10 having the entire optical thin film 12 finally formed are measured in step S6; accordingly, feedback can be performed in which this information is reflected in the film formation of the next optical thin film 12 on the next substrate 11. Consequently, an optical thin film 12 which has desired optical characteristics that are more accurately reproduced can be obtained. In particular, if the layer that determines the timing of the measurement of the optical characteristics in the actual-use wavelength region is set not only as the uppermost layer Mn, but also as one or more other layers, the spectroscopic transmissivity characteristics in the actual-use wavelength region in a stage in which the film has been formed up to the point of an intermediate layer are also measured, and feedback can be performed in which this information is also reflected in the film formation of the next optical thin film 12 on the next substrate 11.

In this case, an optical thin film 12 which has desired optical characteristics that are reproduced much more accurately can be obtained. Furthermore, in the present embodiment, since an actual-use wavelength region infrared monitor 6 is installed separately from the film thickness measurement infrared monitor 5, the characteristics in the actual-use wavelength region can be measured with an extremely high resolution. Accordingly, this is advantageous in that an optical thin film 12 which has desired optical characteristics that can be reproduced much more accurately can be obtained from this standpoint as well.

On the other hand, in a conventional film forming apparatus, since only a visible region optical characteristic monitor is mounted, the optical characteristics of the optical member 10 in the actual-use wavelength region within the infrared region cannot be measured, so that the feedback of information in the actual-use wavelength region as described above is completely impossible.

Secondly, in the present embodiment, if the measurement mode of the film thickness monitoring optical measurements that are performed in step S4 is set as the infrared region measurement mode, then the film thickness monitoring optical measurements are performed by the film thickness monitoring infrared monitor 5 as described above, and the film thicknesses of the respective layers are determined from the spectroscopic characteristics in the infrared region obtained by these measurements. Since the wavelengths in the infrared region are longer than the wavelengths in the visible region, a large and abrupt repetitive variation with respect to changes in wavelength is less likely to appear in the infrared region than in the visible region, even if the total film thickness or number of layers formed is large.

Accordingly, in the present embodiment, if the measurement mode is set as the infrared region measurement mode, even if the total film thickness or number of layers formed is large, the film thicknesses of the respective layers can be determined with greater precision than in cases where the film thicknesses of the respective layers are determined from the spectroscopic characteristics in the visible region as in a conventional film forming apparatus; consequently, it is possible to obtain an optical thin film 12 with desired optical characteristics that are accurately reproduced. Thus, since the film thicknesses of the respective layers can be precisely measured in cases where the measurement mode is set as the infrared region measurement mode even if the total film thickness or number of layers formed is large, the need to replace the monitoring substrate 21 during film formation can be completely eliminated, or the frequency of such replacement can be reduced even if the total film thickness of the optical thin film 12 is large; consequently, the productivity is greatly improved.

In cases where the need to replace the monitoring substrate 21 is completely eliminated, if the substrate 11 that constitutes the optical member 10 is (for example) a flat plate, the spectroscopic characteristics of the substrate 11 may be measured by the film thickness monitoring infrared monitor 5. In this case, since there is no need to use a monitoring substrate 21, the productivity can be further improved.

Thirdly, in the present embodiment, if the measurement mode of the film thickness monitoring optical measurements that are performed in step S4 is set as the visible region measurement mode, then the film thickness monitoring optical measurements are performed by the visible region monitor 4 as described above, and the film thicknesses of the respective layers are determined from the spectroscopic characteristics in the visible region obtained by these measurements. Accordingly, in cases where the total film thickness or number of layers of the optical thin film 12 is large, the monitoring substrate 21 must be replaced during film formation as in a conventional film forming apparatus in order to obtain the film thicknesses of the respective layers with good precision. Consequently, this embodiment of the film forming apparatus of the present invention is comparable to a conventional film forming apparatus in terms of productivity. However, since the wavelengths in the visible region are shorter than the wavelengths in the infrared region, the spectroscopic characteristics in the visible region can be measured with good sensitivity compared to the spectroscopic characteristics in the infrared region in cases where the total film thickness or number of layers formed is small.

Accordingly, if the measurement mode is set as the visible region measurement mode, although the productivity is inferior to that obtained when the measurement mode is set as the infrared region measurement mode in cases where the total film thickness or number of layers of the optical thin film 12 is large, the film thicknesses of the respective layers can be obtained with greater precision, so that an optical thin film 12 which has desired optical characteristics that can be reproduced with greater accuracy can be obtained. Of course, this advantage that is obtained in case where the measurement mode is set as the visible region measurement mode is an advantage that is also obtained in the conventional film forming apparatus described above. However, in the visible region measurement mode of the present embodiment, this advantage is obtained simultaneously with the first advantage describe above; accordingly, the technical significance of this advantage is extremely high.

### SECOND EMBODIMENT

FIGS. 7 and 8 are schematic flow charts which illustrate the operation of a film forming apparatus constituting a second embodiment of the present invention.

The film forming apparatus constituting the present embodiment differs from the film forming apparatus constituting the first embodiment described above only in the following respect: namely, in the first embodiment described above, the control and calculation processing part 17 is constructed so that the operation shown in FIG. 6 described above is realized, while in the present embodiment, the control and calculation processing part 17 is constructed so that the operation shown in FIGS. 7 and 8 is realized. In all other respects, the film forming apparatus of the present embodiment is the same as that of the first embodiment described above. Here, therefore, the operation shown in FIGS. 7 and 8 will be described; since other descriptions are redundant, such other descriptions will be omitted.

Film formation is initiated in a state in which the substrates 11 and monitoring substrate 21 on which no films have yet been formed are attached to the rotating table 2.

First, the user performs initial settings by operating the operating part 18 (step S21). In these initial settings, setting information indicating whether the film thickness determination mode is set as the mode using one wavelength region or the mode using both wavelength regions is input. Here, the term “film thickness determination mode” refers to the system used to determine the film thickness of the layer formed as the uppermost layer at the point in time in question. Furthermore, the term “mode using one wavelength region” refers to a system in which the film thickness of this layer is determined with only one type of spectroscopic transmissivity value among the spectroscopic transmissivity values measured by the visible region optical monitor 4 and the spectroscopic transmissivity values measured by the film thickness measurement infrared monitor 5 being selectively used as the measurement data. Moreover, the term “mode using both wavelength regions” refers to a system in which the film thickness of this layer is determined using both the spectroscopic transmissivity values measured by the visible region optical monitor 4 and the spectroscopic transmissivity values measured by the film thickness measurement infrared monitor 5. Furthermore, the same film thickness determination mode is used for all of the layers M1 through Mn.

Furthermore, in the initial settings in step S21, a tolerance Ti corresponding to each of the layer numbers m is set which is used in the mode using both wavelength regions. This point will be described in detail later.

Furthermore, in the initial settings in step S21, the set film thickness values, materials, numbers of layers n, film formation conditions, and the like for the respective layers M1 through Mn are input which are such that the desired optical characteristics of the optical member 10 can be obtained, and which are predetermined according to advance design or the like. Moreover, it would also be possible to provide the control and calculation processing part 17 with a design function for the optical thin film 12 so that the control and calculation processing part 17 automatically determines the set film thickness values, materials, numbers of layers n, film formation conditions, and the like for the respective layers M1 through Mn by means of this design function when the user inputs the desired optical characteristics.

Furthermore, in the initial settings in step S21, setting information indicating the layer of film formation at which the actual-use wavelength region optical measurements of step S27 (described later) are to be performed (and the like) is also input. In the selection of this layer, for example, one or more arbitrary layers other than the uppermost layer Mn (e.g., layers separated by a specified number of layers) may be selected, the uppermost layer Mn and one or more other arbitrary layers may be selected, or all of the layers M1 through Mn may be selected. Furthermore, the uppermost layer Mn alone may be selected, or a setting may be used in which no layer is selected, so that the actual-use wavelength region optical measurements of step S27 are not performed for any of the layers. However, it is desirable to select at least one layer other than the uppermost layer Mn.

Next, the control and calculation processing part 17 sets a count value m which indicates the number of the current layer (i.e., the layer number) as counted from the side of the substrate 11 at 1 (step S22).

Next, under the control of the control and calculation processing part 17, the film formation of the mth layer is performed (for example) using time control on the basis of the set film thickness values and film formation conditions, etc., that were set for this layer (step S23). In the case of the first layer M1, the layer is formed on the basis of the set film thickness value that was set in step S21; however, in the case of layers from the second layer on, if the set film thickness value has been adjusted in step S39 (described later), the layer is formed on the basis of the most recently adjusted set film thickness value. During film formation, the rotating table 2 is caused to rotate, and only the shutter (not shown in the figures) installed facing the sputtering source 3 corresponding to the material of the mth layer is opened, so that particles from this sputtering source 3 are deposited on the respective substrates 11 and monitoring substrate 21. When the film formation of the mth layer is completed, this shutter is closed.

Subsequently, under the control of the control and calculation processing part 17, the spectroscopic transmissivity of the monitoring substrate 21 or substrates 11 in the specified wavelength region within the visible region described above is measured by the visible region optical monitor 4, and this data is stored in the memory 20 in association with the current count value m (step S24). The measurements performed by the visible region optical monitor 4 are performed when the monitoring substrate 21 or substrate 11 in question is positioned between the light emitting device 4a and light receiving device 4b in a state in which the rotating table 2 is rotating, or with the rotating table 2 stopped in a state in which the monitoring substrate 21 or substrate 11 is positioned between the light emitting device 4a and light receiving device 4b.

Next, under the control of the control and calculation processing part 17, the spectroscopic transmissivity of the monitoring substrate 21 or substrate 11 in question in the specified wavelength region within the infrared region described above is measured by the film thickness measurement infrared monitor 5, and this data is stored in the memory 20 in association with the current count value m (step S25). The measurements performed by the film thickness measurement infrared monitor 5 are performed when the monitoring substrate 21 or substrate 11 in question is positioned between the light emitting device 6a and light receiving device 5b in a state in which the rotating table 2 is rotating, or with the rotating table 2 stopped in a state in which the monitoring substrate 21 or substrate 11 is positioned between the light emitting device 5a and light receiving device 5b.

Next, on the basis of the setting information set in step S21, the control and calculation processing part 17 judges whether or not the actual-use wavelength region optical measurements of step S27 are to be performed at the point in time at which film formation has been performed up to the current mth layer (i.e., in a state in which the mth layer has been formed as the uppermost layer) (step S26). If it is judged that the actual-use wavelength region optical measurements are not to be performed, the processing proceeds directly to step S28; if it is judged that the actual-use wavelength region optical measurements are to be performed, the processing proceeds to step S28 after passing through step S27.

In step S27, the spectroscopic transmissivity of the monitoring substrate 21 or substrate 11 in the actual-use wavelength region described above is measured by the actual-use wavelength region infrared monitor 6, and this data is stored in the memory 20. The measurements performed by the actual-use wavelength region infrared monitor 6 are performed when the substrate 11 in question is positioned between the light emitting device 6a and light receiving device 6b in a state in which the rotating table 2 is rotating, or with the rotating table 2 stopped in a state in which the substrate 11 is positioned between the light emitting device 6a and light receiving device 6b.

In step S28, the control and calculation processing part 17 judges whether the film thickness determination mode set in step S21 is the mode using one wavelength region or the mode using both wavelength regions. If this mode is the mode using one wavelength region, the processing proceeds to step S29; if the mode is the mode using both wavelength regions, the processing proceeds to step S32.

In step S29, the control and calculation processing part 17 judges whether or not the total film thickness of the layers from the first through mth layers is less than 10 μm. However, since the film thickness of the mth layer has not yet been determined at this point in time, the judgement of step S29 is performed with the sum of the respective film thicknesses of the layers from the first through (m−1)th layers that have already been determined in step S30 or step S31 and the set film thickness value for the mth layer taken as the total film thickness of the layers from the first through mth layers.

The judgement reference value used in step S29 is not limited to 10 μm; it is desirable to set this value as a specified value in the range of 1 μm to 10 μm, and it is even more desirable to set this value as a specified value in the range of 6 μm to 10 μm. The reasons for setting these values has already been described. Instead of judging the total film thickness in step S29, it would also be possible to judge the number of layers that have been formed up to the current time (i.e., the count value). In cases where a judgement is made on the basis of the number of layers, the approximate total film thickness can be calculated from the number of layers since the film thickness per layer shows no great variation.

Accordingly, a procedure in which the number of layers that produces a specified total film thickness is calculated, and the judgement reference value in step S29 is set on the basis of this number of layers, is also included in the scope of the present invention. If the total film thickness is less than 10 μm, the processing proceeds to step S30, and if the total film thickness is 10 μm or greater, the processing proceeds to step S31.

In step S30, the control and calculation processing part 17 determines the film thickness of the mth layer using only the spectroscopic transmissivity in the visible region measured in step S24, without using the spectroscopic transmissivity in the infrared region measured in step S25 by fitting the corresponding spectroscopic transmissivity calculated with the thickness of the mth layer assumed as various values to this measured spectroscopic transmissivity in the visible region.

Here, the corresponding spectroscopic transmissivity is the spectroscopic transmissivity of a multi-layer film model (thin film model) comprising layers from the first through mth layers. In the calculation of the spectroscopic transmissivity of this multi-layer film model, the film thicknesses that have already been determined in step S30 or step S31 are used as the respective film thicknesses of the layers from the first through (m−1)th layers. When step S30 is completed, the processing proceeds to step S34.

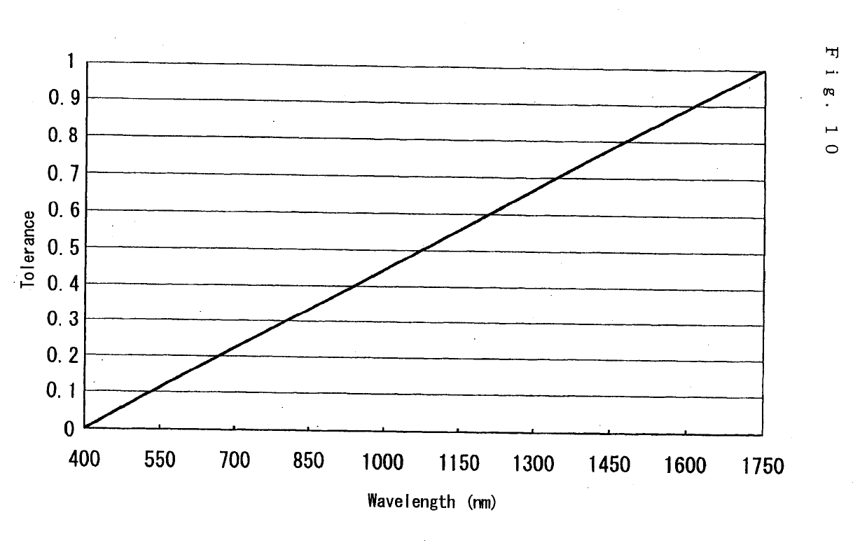

Here, one example of the spectroscopic transmissivity in the infrared region measured in step S25 is shown as the measured transmissivity in FIG. 9. Furthermore, the spectroscopic transmissivity calculated with the film thickness of the uppermost layer assumed to be a certain thickness (corresponding to the measured transmissivity) is shown as the calculated transmissivity in FIG. 9. In the example shown in FIG. 9, since the assumed film thicknesses show a considerable deviation from the actual film thicknesses, there is a considerable deviation between the measured spectroscopic transmissivity and the calculated spectroscopic transmissivity.

In the fitting of the calculated spectroscopic transmissivity to the measured spectroscopic transmissivity, an evaluation value which evaluates the deviation between the respective values (or conversely, the degree of fitting) is calculated. This evaluation value is calculated for each film thickness with the film thickness of the mth layer assumed as various values. Furthermore, the film thickness that is assumed when the evaluation value (among all of the evaluation values) that shows the smallest deviation (the minimum value in the case of the merit value MF described later) is calculated is determined to be the film thickness of the mth layer. This is the concrete content of the fitting processing.

In the present embodiment, a merit value MF based on a merit function is used as the evaluation value that is used in the fitting of step S30. Of course, it goes without saying that evaluation values that can be used are not limited to such a merit value MF. The definition of this merit value MF is shown in the following

$$\begin{matrix}Equation ( 1 ) . & \\ MF = \sqrt{\frac{1}{N} {\sum }_{i = 1}^{N} {( \frac{{Q}_{i}^{target} - {Q}_{i}^{calc}}{{T}_{i}} )}^{2}} & ( 1 )\end{matrix}$$

In Equation (1), N is the total number of targets (total number of transmissivity values at respective wavelengths in the measured transmissivity characteristics). i is a number corresponding to the wavelength in a one-to-one correspondence, and is a number that is attached to quantities relating to a certain wavelength. This number may have any value from 1 to N. Q^{target} is the transmissivity value in the measured transmissivity characteristics. Q^{calc} is the transmissivity value in the calculated transmissivity characteristics. T is the tolerance (the reciprocal of this value is generally called the weighting factor).

When Equation (1) is applied in step S30, Q^{target}^{₁} through Q^{target}^{_{N}} in Equation (1) are the transmissivity values in the spectroscopic transmissivity in the visible region measured in step S24. Furthermore, in the present embodiment, in cases where the merit value MF is used in step S30, the tolerance values Ti (i is 1 through N) are all set at 1, and none of the data of the respective transmissivity values is weighted, so that these sets of data are all treated equally.

Referring again to FIG. 7, in step S31, the control and calculation processing part 17 determines the film thickness of the mth layer using only the spectroscopic transmissivity in the infrared region measured in step S25, without using the spectroscopic transmissivity in the visible region measured in step S24, by fitting the corresponding spectroscopic transmissivity that is calculated with the thickness of the mth layer assumed as various values to this measured spectroscopic transmissivity in the infrared region. In the present embodiment, the processing of step S31 is the same processing as the processing of step S30, except for the fact that the spectroscopic transmissivity in the infrared region measured in step S25 is used instead of the spectroscopic transmissivity in the visible region measured in step S24. When Equation (1) is applied in step S31, Q^{target}^{₁} through Q^{target}^{_{N}} in Equation (1) are the transmissivity values in the spectroscopic transmissivity in the infrared region measured in step S25. When step S31 is completed, the processing proceeds to step S34.

In cases where the film thickness determination mode set in step S21 is the mode using both wavelength regions, the control and calculation processing part 17, in step S32, determines the tolerance Ti corresponding to the current layer number m (this layer number m indicates the number of layers currently formed) from the tolerances set in step S21.

Subsequently, in step S33, the control and calculation processing part 17 determines the film thickness of the mth layer using the overall spectroscopic transmissivity that combines both the spectroscopic transmissivity in the visible region measured in step S24 and the spectroscopic transmissivity in the infrared region measured in step S25, by fitting the corresponding spectroscopic transmissivity calculated with the thickness of the mth layer assumed as various values to this measured overall spectroscopic transmissivity. When step S33 is completed, the processing proceeds to step S34.

In the present embodiment, the merit value MF is used as the evaluation value in the fitting of step S33 as well. When Equation (1) is applied in step S33, Q^{target}^{₁} through Q^{target}^{_{N}} in Equation (1) are the transmissivity values in the spectroscopic transmissivity in the visible region measured in step S24 and the transmissivity values in the spectroscopic transmissivity in the infrared region measured in step S25.

In steps S30 and S31, the tolerance values Ti (i is 1 through N) were all set at 1, so that none of the data of the respective transmissivity values was weighted. In step S33, on the other hand, the tolerance values Ti determined in step S32 are used, and the data of the respective transmissivity values is weighted by appropriately setting the tolerance Ti for each of the layer numbers m in step S21. In the present embodiment, in cases where the number of layers m currently formed is equal to or less than a specified number of layers, the tolerance Ti for each of the number of layers m is set in step S21 so that fitting is performed in step S33 with a greater emphasis on the spectroscopic transmissivity in the visible region measured in step S24 than on the spectroscopic transmissivity in the infrared region measured in step S25, and in cases where the number of layers m currently formed is greater than this specified number of layers, the tolerance Ti for each of the number of layers m is set in step S21 so that fitting is performed in step S33 with a greater emphasis on the spectroscopic transmissivity in the infrared region measured in step S25 than on the spectroscopic transmissivity in the visible region measured in step S24. Here, the term “emphasis” refers to weighting of the data of the evaluation value described above. In cases where the evaluation value is the merit value MF, this refers to a relative reduction of the tolerance.

Here, a concrete example of the setting of the tolerance Ti for each of the number of layers m in step S21 will be described in combination with a description of the significance of the tolerance setting.

In the concrete example described below, the wavelength range of the overall transmissivity characteristics obtained by the visible region optical monitor 4 and film thickness measurement infrared monitor 5 is 400 nm to 1750 nm. The tolerance in the merit function (Equation (1)) that is used when the film thickness is determined by fitting to the transmissivity characteristics thus obtained is positively controlled. Since the tolerance can be set for the transmissivity characteristics values at each wavelength, relative reduction of the tolerance means that it is desired to increase the degree of fitting to the measured value of the transmissivity at the wavelength in question. Conversely, a relative increase in the tolerance means that the degree of fitting to the measured value of the transmissivity at the wavelength in question may be relatively poor.

For example, in cases where the total film thickness of the multi-layer film on the monitoring substrate 21 or substrate 11 is not very large, the visible region transmissivity characteristics obtained by the visible region optical monitor 4 are emphasized; accordingly, the tolerance in the visible region is reduced to a tolerance that is smaller than the tolerance in the infrared region. As the total film thickness of the multi-layer film on the monitoring substrate 21 or substrate 11 increases, the tolerance in the visible region is increased, and the tolerance in the infrared region is reduced. By proceeding in this way, it is possible to suppress the error that is caused mainly by the resolution of the optical monitor, so that film formation can be continued without causing a drop in the precision of film thickness determination.

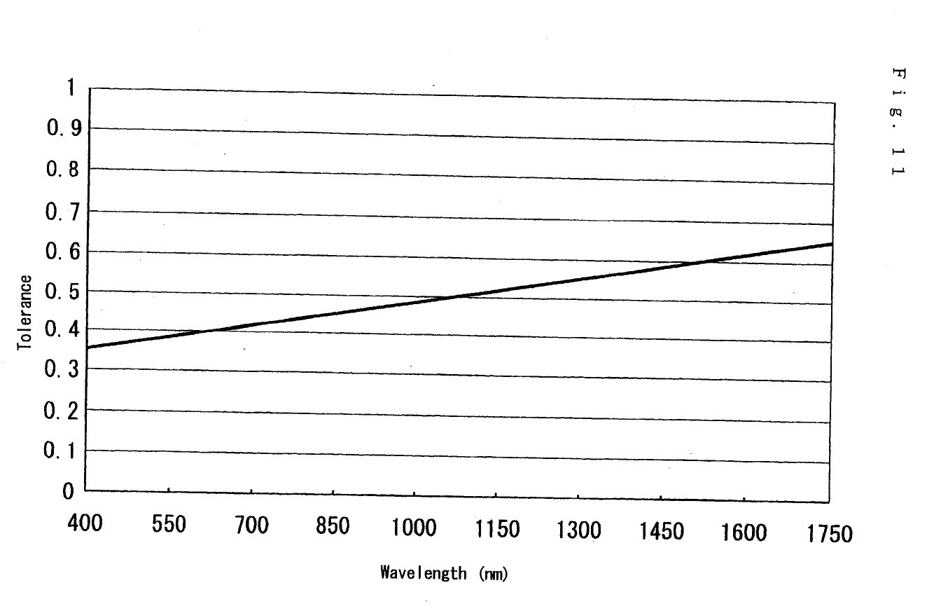

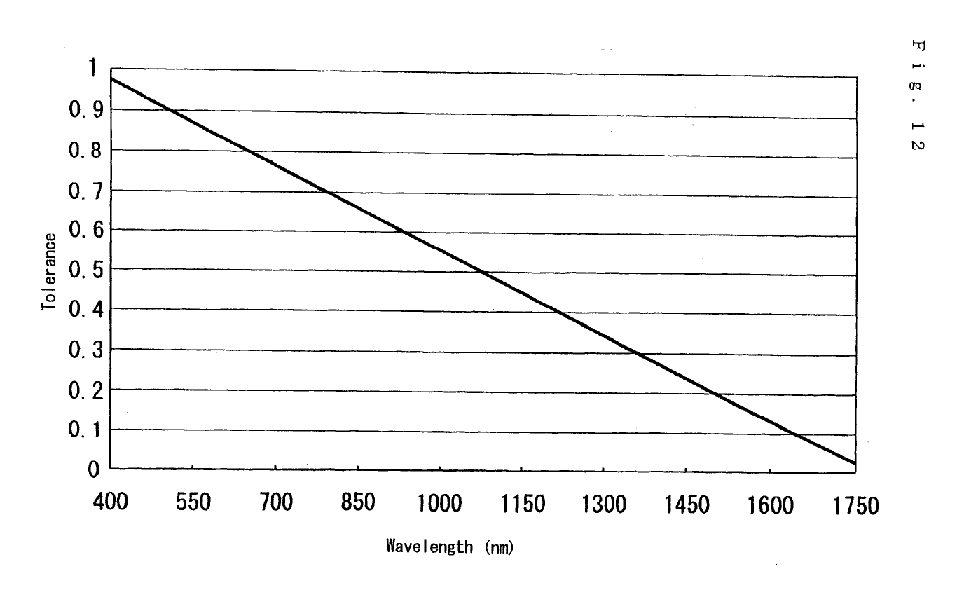

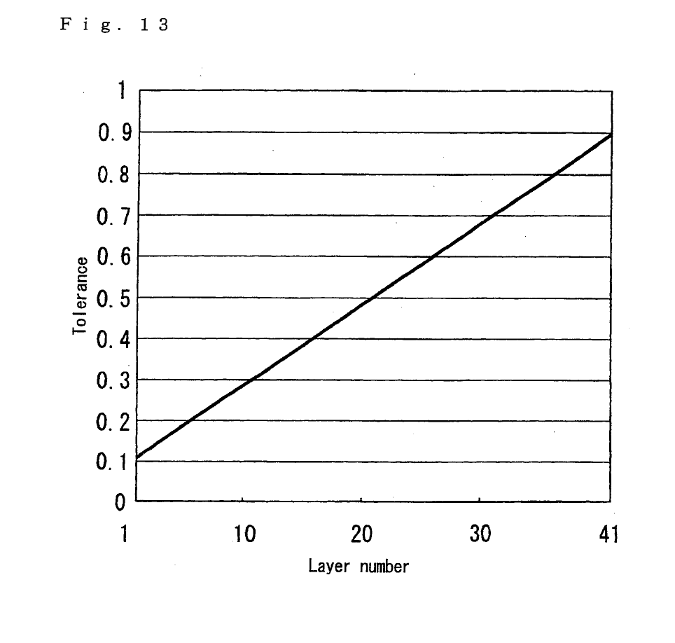

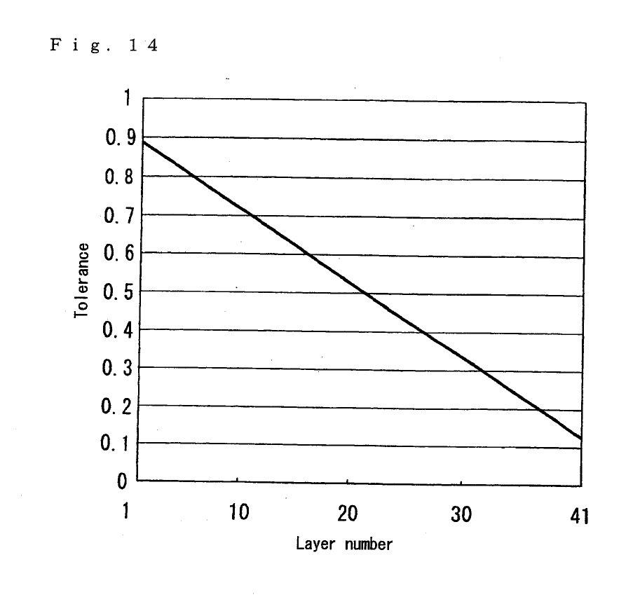

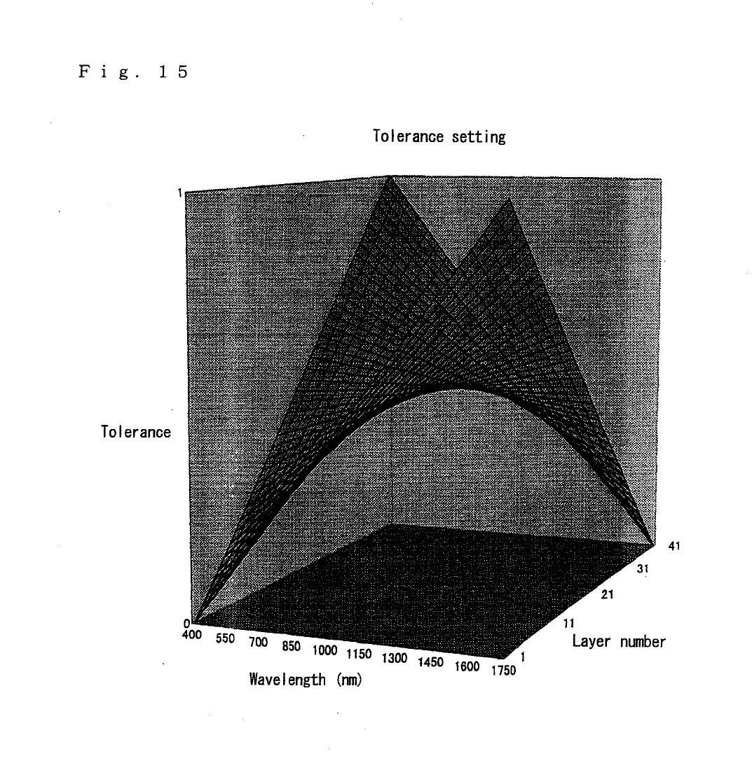

Values that varied linearly with wavelength were used as the set tolerance values in a case where a 41-layer film in which the thicknesses of all of the layers were more or less the same was actually formed on the monitoring substrate 21 (the layer film thickness was approximately 15 microns). The tolerance settings for the first layer, fifteenth layer and fortieth layer are shown in FIGS. 10, 11 and 12, respectively. Furthermore, the tolerance setting for the layer number at a wavelength of 550 nm is shown in FIG. 13, and the tolerance setting for the layer number at a wavelength of 1600 nm is shown in FIG. 14.

FIG. 15 is a diagram in which these tolerance settings are shown comprehensively in three dimensions. By varying the first-order slope of the tolerance vs. wavelength as the layers progress, it is possible to change from an emphasis on the visible region transmissivity characteristics to an emphasis on the infrared region transmissivity characteristics in the determination of the film thickness as the total film thickness of the multi-layer film on the monitoring substrate 21 increases. The linear variation of the tolerance shown here is merely one example; in regard to the manner of this variation, it goes without saying that the tolerance can be varied in the most appropriate form in accordance with the film construction of the multi-layer film and the conditions of the optical monitors, etc.

Returning again to the description in the flow chart, the control and calculation processing part 17 judges in step S34 whether or not the actual-use wavelength region optical measurements of step S27 have already been performed at the time that the film was formed up to the current mth layer (i.e., in a state in which the mth layer was formed as the uppermost layer). In cases where the actual-use wavelength region optical measurements have been performed, the processing proceeds to step S35; in cases where the actual-use wavelength region optical measurements have not been performed, the processing proceeds to step S38.

In step S35, the control and calculation processing part 17 calculates the evaluation value of the deviation between the spectroscopic transmissivity in the actual-use wavelength region measured in step S27 and the corresponding spectroscopic transmissivity that has been calculated. Here, the corresponding spectroscopic transmissivity is the spectroscopic transmissivity of a multi-layer film model (thin film model) comprising layers from the first through mth layers. In the calculation of the spectroscopic transmissivity of this multi-layer film model, the film thicknesses already determined in steps S30, S31 or S33 are used as the respective film thicknesses of the layers from the first through mth layers.

For example, the merit value MF can be used as the evaluation value that is calculated in step S35. In cases where the merit value MF is used as this evaluation value, since weighting has no particular meaning, the tolerance values Ti (i is 1 through N) may all be set at 1. When Equation (1) is applied in step S34, Q^{target}^{₁} through Q^{target}^{_{N}} in Equation (1) are the transmissivity values in the spectroscopic transmissivity in the actual-use wavelength region measured in step S27.

Subsequently, the control and calculation processing part 17 judges whether or not the evaluation value calculated in step S35 is within the permissible range (step S36). If this value is within the permissible range, the processing proceeds to step S38. On the other hand, if this value is not within the permissible range, the spectroscopic transmissivity characteristics in the actual-use wavelength region measured in each step S27, and the film thicknesses of the respective layers determined in each step S30, S31 and S33, which are stored in the memory 20 are displayed on the display part 19 along with the associated count values m (information indicating which layer was formed as the uppermost layer at the time of this data). If necessary, furthermore, this data is output to an external personal computer or the like (step S37), and film formation is stopped. Accordingly, even if the mth layer is an intermediate layer, the film formation of the layers from the (m+1)th layer on is not performed.

In cases where film formation is thus stopped at an intermediate point, the user appropriately adjusts (for example) the refractive index dispersion data constituting one of the conditions of the multi-layer film model calculated in steps S30, S31 and S33, and forms the next optical thin film 12 on the next substrate 11.

In step S38, the control and calculation processing part 17 judges whether or not m=n, i.e., whether or not film formation has been completed up to the final values of the layers from the (m+1)th layer on (layers that have not yet been formed) are adjusted and optimized on the basis of the respective film thicknesses of the layers up to the mth layer determined in steps S30, S31 or S33 for each layer so that the optical characteristics of the optical member 10 that is ultimately obtained are the desired optical characteristics (step S39). For example, such optimization can be accomplished using various universally known procedures. The set film thickness values of the layers from the (m+1)th layer on that are adjusted in step S39 are used in step S23 in the film formation of the layers from the (m+1)th layer on. Following the adjustment of step S39, the count value m of the number of layers is increased by 1 (step S40), and the processing returns to step S23.

On the other hand, in cases where it is judged in step S38 that film formation has been completed up to the final layer Mn, the formation of the optical thin film 12 on the substrate 11 in question is completed after processing similar to that of step S37 is performed in step S41.

An optical member 10 can be manufactured in this manner.

In the present embodiment, advantages similar to those of the first embodiment are obtained; in addition, the following advantages can also be obtained:

In the present embodiment, in the case of mode using one wavelength region, the film thicknesses of the respective layers are determined on the basis of the spectroscopic transmissivity in the visible region measured by the visible region optical monitor 4 when the total film thickness is less than 10 μm, and are determined on the basis of the spectroscopic transmissivity in the infrared region measured by the film thickness measurement infrared monitor 5 when the total film thickness is 10 μm or greater. Since the wavelengths in the infrared region are longer than the wavelengths in the visible region, a large and abrupt repetitive variation with respect to changes in wavelength is less likely to appear in the infrared region than in the visible region even if the total film thickness or number of layers formed is large. Accordingly, in the present embodiment, if the measurement mode is set as the infrared region measurement mode, the film thicknesses of the respective layers can be determined with greater precision than is possible in cases where the film thicknesses of the respective layers are determined from the spectroscopic characteristics in the visible region as in a conventional film forming apparatus, even if the total film thickness or number of layers formed is large. Consequently, an optical thin film 12 with desired optical characteristics that are accurately reproduced can be obtained. Thus, since the film thicknesses of the respective layers can be precisely measured even if the total film thickness or number of layers formed is large, the need to replace the monitoring substrate 21 during film formation can be completely eliminated, or the frequency of such replacement can be reduced even if the total film thickness of the optical thin film 12 is large; consequently, the productivity can be greatly improved. In cases where the need to replace the monitoring substrate 21 is completely eliminated, the spectroscopic characteristics of the substrate 11 that constitutes the optical member 10 can also be measured by means of the film thickness monitoring infrared monitor 5 if this substrate 11 is (for example) a flat plate. In this case, there is no need to use a monitoring substrate 21, accordingly, the productivity can be increased even further.

Furthermore, in the present embodiment, in the case of the mode using both wavelength regions, fitting is performed with a greater emphasis on the spectroscopic transmissivity in the visible region measured by the visible region optical monitor 4 than on the spectroscopic transmissivity measured by the film thickness measurement infrared monitor 5 in cases where the number of layers formed is equal to or less than a specified number of layers, and fitting is performed with a greater emphasis on the spectroscopic transmissivity measured by the film thickness measurement infrared monitor 5 than on the spectroscopic transmissivity measured by the visible region optical monitor 4 in cases where the number of layers formed is greater than this specified number of layers.

Accordingly, advantages that are basically the same as those obtained in the case of the mode using one wavelength region are also obtained in the case of the mode using both wavelength regions. In the case of the mode using both wavelength regions, unlike the case of the mode using one wavelength region, there is no complete switching between the use of the spectroscopic transmissivity in the visible region and the use of the spectroscopic transmissivity in the infrared region; instead, the contributions of both regions can be freely varied by appropriately setting the tolerance. Accordingly, the film thicknesses can be determined with higher precision in the case of the mode using both wavelength regions than in the case of the mode using one wavelength region.

Furthermore, in the present embodiment, the processing of steps S35 and S36 is performed, and in cases where the evaluation value of the deviation between the spectroscopic transmissivity in the actual-use wavelength region and the corresponding spectroscopic transmissivity that is calculated is outside a permissible range, film formation is performed only up to an intermediate layer, and the film formation of the remaining layers is stopped. Accordingly, in the present embodiment, a check can be made at an intermediate stage in the film formation of the multi-layer film in order to ascertain if the performance of the optical multi-layer film that will ultimately be obtained has no prospect of satisfying the performance requirements. In cases where there is no prospect that these requirements will be satisfied, the wasteful formation of the remaining layers up to the final layer can be avoided Accordingly, the production efficiency can be greatly improved by using the present invention.

Respective embodiments of the present invention were described above. However, the present invention is not limited to these embodiments.

For example, it would also be possible to modify the first embodiment so that only the infrared measurement mode described above is always performed. In this case, the visible region optical monitor 4 can be eliminated.

Furthermore, it would also be possible to modify the first embodiment so that only the visible region measurement mode described above is always performed. In this case, the film thickness monitoring infrared monitor 5 can be eliminated.

Moreover it would also be possible to modify the second embodiment so that only the mode using one wavelength region or only the mode using both wavelength regions is always performed.

Furthermore, in the second embodiment, it would also be possible to devise the system so that tolerance values Ti are set for respective total film thicknesses in step S21 in FIG. 7, and the tolerance value Ti corresponding to the total film thickness is determined in step S32.

In addition, in the first and second embodiments, the optical monitors 4 through 6 were all monitors that measure the spectroscopic transmissivity. However, at least one of the optical monitors 4 through 6 may be an optical monitor that measures the spectroscopic reflectivity.

Furthermore, the first and second embodiments were examples of a sputtering apparatus. However, the present invention may also be applied to other film forming apparatuses such as vacuum evaporation apparatuses.

### INDUSTRIAL APPLICABILITY

The film forming apparatus of the present invention can be used to form optical thin films and the like. Furthermore, the optical member manufacturing method of the present invention can be used to manufacture optical members that have optical thin films.

1. A method for manufacturing an optical member which has a substrate and an optical thin film consisting of a plurality of layers formed on top of this substrate, this method comprising a step in which the respective layers constituting the optical thin film are successively formed on the basis of set film thickness values for these respective layers, and a step in which the film thicknesses of the respective layers that are formed are determined on the basis of the spectroscopic characteristics measured by at least one optical monitor among a first optical monitor that measures the spectroscopic characteristics arising from the formed layers in a first wavelength region and a second optical monitor that measures the spectroscopic characteristics arising from the formed layers in a second wavelength region.

2. A method for manufacturing an optical member which has a substrate and an optical thin film consisting of a plurality of layers formed on top of this substrate, this method comprising a step in which the respective layers constituting the optical thin film are successively formed on the basis of set film thickness values for these respective layers, a step in which the film thicknesses of the respective layers that are formed are determined on the basis of the spectroscopic characteristics measured by a first optical monitor that measures the spectroscopic characteristics arising from the formed layers in a first wavelength region, and a step in which the set film thickness values or film formation conditions of the respective layers constituting the next optical thin film, which are used to form this next optical thin film on the next substrate, are determined on the basis of the spectroscopic characteristics for at least a portion of the wavelength region among the spectroscopic characteristics measured by a second optical monitor that measures the spectroscopic characteristics arising from the formed layers in a second wavelength region that differs from the first wavelength region in a state in which all of the layers constituting the optical thin film have been formed.

3. A method for manufacturing an optical member which has a substrate and an optical thin film consisting of a plurality of layers formed on top of this substrate, this method comprising a step in which the respective layers constituting the optical thin film are successively formed on the basis of set film thickness values for these respective layers, a step in which the film thicknesses of the respective layers that are formed are determined on the basis of the spectroscopic characteristics measured by a first optical monitor that measures the spectroscopic characteristics arising from the formed layers in a first wavelength region, and a step in which the set film thickness values or film formation conditions of the respective layers constituting the next optical thin film, which are used to form this next optical thin film on the next substrate, are determined on the basis of the respective spectroscopic characteristics for at least a portion of the wavelength region among the respective spectroscopic characteristics measured by a second optical monitor that measures the spectroscopic characteristics arising from the formed layers in a second wavelength region that differs from the first wavelength region in a state in which only some of the layers constituting the optical thin film have been formed and in a state in which all of the layers constituting the optical thin film have been formed.

4. The method for manufacturing an optical member according to claim 1, which is characterized in that the method further comprises a step in which the set film thickness values of layers that are formed subsequent to at least one of the layers constituting the optical thin film are adjusted on the basis of the film thickness determined for this layer in the step in which the film thickness is determined in a state in which this layer has been formed as the uppermost layer.

5. The method for manufacturing an optical member according to claim 1, which is characterized in that the first wavelength region is a wavelength region within the visible region, and the second wavelength region is a wavelength region within the infrared region.

6. The method for manufacturing an optical member according to claim 5, which is characterized in that the optical thin film is used in a specified wavelength region within the infrared region, and the second wavelength region includes the specified wavelength region in which the optical thin film is used.

7. The method for manufacturing an optical member according to claim 1, which is characterized in that the first and second wavelength regions are wavelength regions within the infrared region, and the second wavelength region is a partial wavelength region within the first wavelength region.

8. The method for manufacturing an optical member according to claim 7, which is characterized in that the optical thin film is used in a specified wavelength region within the infrared region, and the second wavelength region includes the specified wavelength region in which the optical thin film is used.

9. The method for manufacturing an optical member according to claim 2, which is characterized in that the method further comprises a step in which the set film thickness values of layers that are formed subsequent to at least one of the layers constituting the optical thin film are adjusted on the basis of the film thickness determined for this layer in the step in which the film thickness is determined in a state in which this layer has been formed as the uppermost layer.

10. The method for manufacturing an optical member according to claim 2, which is characterized in that the first wavelength region is a wavelength region within the visible region, and the second wavelength region is a wavelength region within the infrared region.

11. The method for manufacturing an optical member according to claim 10, which is characterized in that the optical thin film is used in a specified wavelength region within the infrared region, and the second wavelength region includes the specified wavelength region in which the optical thin film is used.

12. The method for manufacturing an optical member according to claim 2, which is characterized in that the first and second wavelength regions are wavelength regions within the infrared region, and the second wavelength region is a partial wavelength region within the first wavelength region.

13. The method for manufacturing an optical member according to claim 12, which is characterized in that the optical thin film is used in a specified wavelength region within the infrared region, and the second wavelength region includes the specified wavelength region in which the optical thin film is used.

14. The method for manufacturing an optical member according to claim 3, which is characterized in that the method further comprises a step in which the set film thickness values of layers that are formed subsequent to at least one of the layers constituting the optical thin film are adjusted on the basis of the film thickness determined for this layer in the step in which the film thickness is determined in a state in which this layer has been formed as the uppermost layer.

15. The method for manufacturing an optical member according to claim 3, which is characterized in that the first wavelength region is a wavelength region within the visible region, and the second wavelength region is a wavelength region within the infrared region.

16. The method for manufacturing an optical member according to claim 15, which is characterized in that the optical thin film is used in a specified wavelength region within the infrared region, and the second wavelength region includes the specified wavelength region in which the optical thin film is used.

17. The method for manufacturing an optical member according to claim 3, which is characterized in that the first and second wavelength regions are wavelength regions within the infrared region, and the second wavelength region is a partial wavelength region within the first wavelength region.

18. The method for manufacturing an optical member according to claim 17, which is characterized in that the optical thin film is used in a specified wavelength region within the infrared region, and the second wavelength region includes the specified wavelength region in which the optical thin film is used.

19. A method for manufacturing an optical member according to claim 1, which has a substrate and an optical thin film having a plurality of layers formed on top of the substrate.
